(19) United States
(12) Patent Application Publication
(10) Pub. No.: US 2012/0242480 A1
(43) Pub. Date: Sep. 27, 2012

(54) Brake Activated Vehicle Warning Side Light System

(76) Inventor: Henry Salazar Moure, Miami, FL (US)

(21) Appl. No.: 13/052,888

(22) Filed: Mar. 21, 2011

(51) Int. Cl. B60Q 1/26

(52) U.S. Cl. 340/468

(57) ABSTRACT

A vehicle warning light system that is incorporated into a vehicle, the vehicle having a front, a rear, and two lateral sides, at least two wheels, each wheel having a hub and possibly a break drum, a power source, a breaking system, and a fender, the vehicle warning light system comprises of at least one LED light mounted on each wheel of the vehicle, and of a controller, the controller programmed to send an on and off signal to each LED light, connected to each LED light and further connected to a power source via a wiring system. The vehicle warning light system warns vehicles approaching vehicles using the warning system, from a lateral angle, that the vehicle using the warning system is either stopped or is preparing to stop.

### BACKGROUND

The present invention relates to a vehicle safety warning light system. The system warns vehicles approaching vehicles using the system that the vehicles using the system are either stopped or coming to a stop.

At the present time, brake lights are installed in the rear of vehicles to warn other vehicles when a vehicle is either stopped or is in the process of stopping. In fact, some newer models of vehicle are equipped to not only place vehicle brake lights on the rear lights of vehicles, they have also been placed on the side view mirrors of vehicles to inform vehicles approaching from the rear that vehicles are either stationary or moving.

The present invention mounts lights on the lateral sides of vehicles to warn vehicles approaching the vehicles using the present invention that the vehicles are either stopped or preparing to stop.

It is documented that many vehicle accidents are side impact accidents that occur when a vehicle is stopped or is preparing to stop at intersections or accident scenes.

The present invention aims to provide a vehicle warning light system that will warn vehicles approaching vehicles using the warning system, from a lateral angle, that the vehicle using the warning system is either stopped or is preparing to stop.

For the foregoing reasons, there is a need for an automobile vehicle warning light system that will warn vehicles approaching vehicles using the warning system, from a lateral angle, that the vehicle using the warning system is either stopped or is preparing to stop.

### SUMMARY

The present invention is directed to a vehicle warning light system that warns vehicles approaching vehicles using the warning system, from a lateral angle, that the vehicle using the warning system is either stopped or is preparing to stop.

The vehicle warning light system of the present invention is incorporated into a vehicle, the vehicle having a front, a rear, and two lateral sides, at least two wheels, each wheel having a hub and possibly a break drum, a power source, a breaking system, and a fender. The vehicle warning light system comprises of at least one LED light mounted on each wheel of the vehicle, and of a controller, the controller programmed to send an on and off signal to each LED light, connected to each LED light and further connected to a power source via a wiring system.

The LED lights of the present invention will be colored so as to comply with local or government ordinances with regards to colored lights that could be mounted on lateral sides of vehicles.

Further embodiments of the present invention might have secondary LED lights, on the fender or on the vehicle at positions adjacent to the fender, that connect to the controller to warn other vehicles of hazards.

The present invention can be used by local police, fire departments, ordinary vehicles, or other vehicles to inform other vehicles that a vehicle is disabled, stopped or coming to a stop. This function is aimed to minimize accidents that normally occur at intersections or accident scenes.

The present invention might be sold as a kit that can be installed on used vehicles or can come pre-installed on newly manufactured vehicles.

An object of the present invention is to provide a vehicle safety device that will maximize the side visibility of stopped or braking vehicles.

Still a further object of the present invention is to provide a safety device that will reduce vehicle side impact accidents.

### DRAWINGS

These and other features, aspects, and advantages of the present invention will become better understood with regard to the following description, appended claims, and drawings where:

FIG. 1 is a perspective view of one of the embodiments of the present invention.

### DESCRIPTION

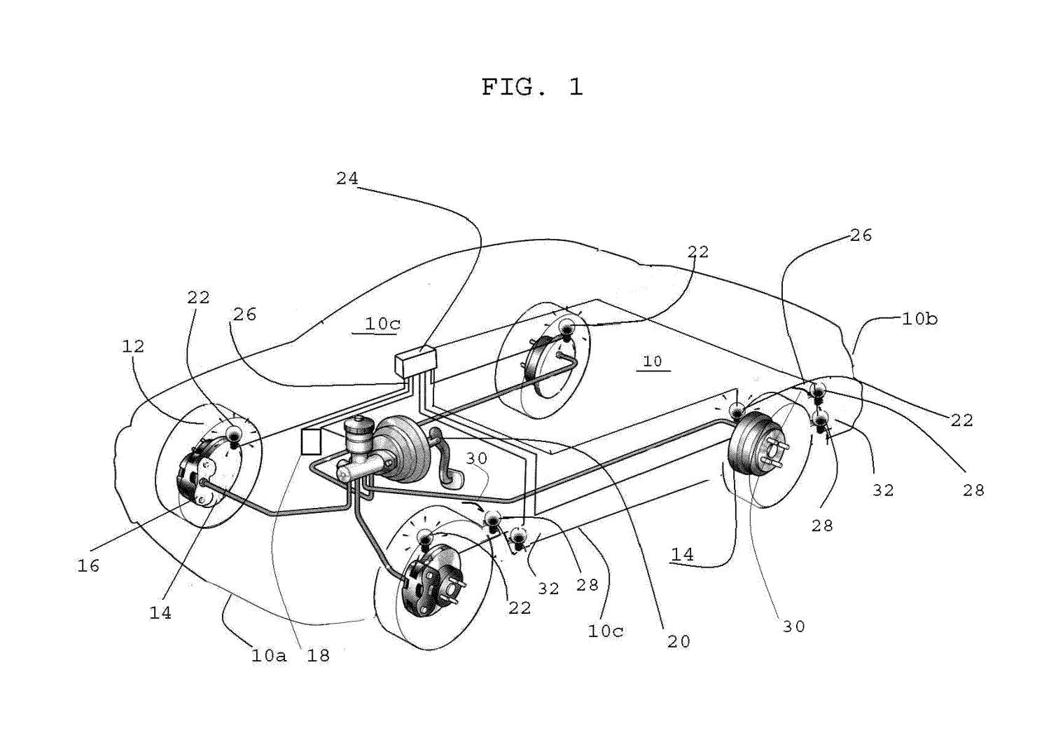

With reference to FIG. 1, a vehicle warning light system that is incorporated into a vehicle 10, the vehicle 10 having a front 10a, a rear 10b, and two lateral 10c sides, at least two wheels 12, each wheel 12 having a hub 14 and possibly a break drum 16, a power source 18, a breaking system 20, and a fender 30, the vehicle warning light system comprises of at least one LED light 22 mounted on each wheel 12 of the vehicle 10, and a controller 24, the controller 24 programmed to send an on and off signal to each LED light 22, connected to each LED light 22 and further connected to a power source 18 via a wiring system 26. The controller 24 might send the on signal to each LED light 22 when the vehicle 10 is turned on and in the parked position.

In another embodiment of the present invention, the vehicle warning light system further comprises of at least a Secondary LED light 28 that shall be placed on each fender 30 or on the vehicle at positions adjacent to each fender 32 of the vehicle 10.

In a further embodiment of the present invention, the controller 24 will send the on signal to each LED light 22, 28 when the vehicle 10 is turned on and the breaking system 20 is activated.

In all embodiments of the present invention, each LED light 22, 28 will be colored, the color will depend on local laws controlling the use of lighting on lateral sides of vehicles. In some embodiments of the present invention, each LED light 22, 28 will be either red or yellow

An advantage of the present invention is that it provides a vehicle safety device that maximizes the side visibility of stopped or braking vehicles.

Still a further advantage of the present invention is that it provides a safety device that reduces vehicle side impact accidents.

Although the present invention has been described in considerable detail in reference to certain preferred versions thereof, other versions are possible. Therefore, the spirit and scope of the claims should not be limited to the description of the preferred versions contained herein.

What is claimed is:

1. A vehicle warning light system that is incorporated into a vehicle, the vehicle having a front, a rear, and two lateral sides, at least two wheels, each wheel having a hub and possibly a break drum, a power source, a breaking system, and a fender, the vehicle warning light system comprises of:
at least one LED light mounted on each wheel of the vehicle; and
a controller, the controller programmed to send an on and off signal to each LED light, connected to each LED light and further connected to a power source via a wiring system.

2. The vehicle warning light system of claim 1, wherein the controller will send the on signal to each LED light when the vehicle is turned on and in the parked position.

3. The vehicle warning light system of claim 2, further comprising of at least a Secondary LED light that shall be placed on each fender or on the vehicle at positions adjacent to each fender of the vehicle that shall also be connected to the controller via the wiring system and that shall work in conjunction to each LED light mounted on each wheel.

4. The vehicle warning light system of claim 3, wherein each LED light will be colored, the color will depend on local laws controlling the use of lighting on lateral sides of vehicles.

5. The vehicle warning system of claim 4, wherein each LED light will be either red or yellow

6. The vehicle warning light system of claim 1, wherein the controller will send the on signal to each LED light when the vehicle is turned on and the breaking system is activated.

7. The vehicle warning light system of claim 6, further comprising of at least a Secondary LED light that shall be placed on each fender or on the vehicle at positions adjacent to each fender of the vehicle that shall also be connected to the controller via the wiring system and that shall work in conjunction to each LED light mounted on each wheel.

8. The vehicle warning light system of claim 7, wherein each LED light will be colored, the color will depend on local laws controlling the use of lighting on lateral sides of vehicles.

9. The vehicle warning system of claim 8, wherein each LED light will be either red or yellow.
